(19) United States
(12) Patent Application Publication
(10) Pub. No.: US 2007/0249803 A1
(43) Pub. Date: Oct. 25, 2007

(54) Synthesis Of Polyaniline

(75) Inventors: Benjamin R. Mattes, Santa Fe, NM (US); Russell M. Goering, Santa Fe, NM (US); Phillip N. Adams, Albuquerque, NM (US); Guido Zuccarello, Silver Spring, MD (US)

Correspondence Address: COCHRAN FREUND & YOUNG LLC, 2026 CARIBOU DR, SUITE 201, FORT COLLINS, CO, 80525, US

(73) Assignee: SANTA FE SCIENCE AND TECHNOLOGY, INC., Santa Fe, NM (US)

(21) Appl. No.: 11/568,507

(22) PCT Filed: Apr. 28, 2004
(86) PCT No.: PCT/US04/13246

§ 371 Date: Oct. 30, 2006

(51) Int. Cl. C08G 73/00

(52) U.S. Cl. 528/422

(57) ABSTRACT

Methods are described for preparing substantially defect-free, adjustable molecular-weight, aniline-based polymers at sub-freezing temperatures in the absence of salts effective for lowering the freezing point of the reacting solutions, and in the absence of inorganic acids containing chlorine atoms.

### STATEMENT REGARDING FEDERAL RIGHTS

This invention was made with government support under Contract No. MDA972-99-C0004 awarded by the U.S. Defense Advance Research Projects Agency to Santa Fe Science and Technology, Inc., Santa Fe, N. Mex. 87507. The government has certain rights in the invention.

### FIELD OF THE INVENTION

The present invention relates generally to the preparation of semi-conductive and conductive organic polymers and, more particularly, to the low-temperature, synthesis of polyaniline-based organic polymers having a chosen molecular weight and being substantially free of defects and ring substitution with chlorine.

### BACKGROUND OF THE INVENTION

Without limiting the scope of the present invention, its background is described in connection with polyaniline polymers made using known methods. Polyaniline is a polymeric material useful for commercial fiber, film, membrane, and coating applications where varying degrees of electrical conductivity are required. However, in spite efforts to develop viable processing routes for polyaniline (PANI), processing barriers intrinsic to this material have not been overcome for: (a) producing practical high-quality fibers having adequate strength; and (b) simultaneously achieving the metallic state conductivity predicted by theory. Melt extrusion is not feasible since this polymer, like many conducting polymers, decomposes before melting. Solution processing of PANI into film, fiber, or coatings is difficult due to: (a) extremely poor solubility in solvents; (b) rapid polymer gelation times at low (3 wt. %) total solids content; and, (c) strong aggregation tendency due to inter-chain attractive forces, for example, hydrogen bonding. Furthermore, these problems prevent utilization of high molecular weight (M_{w}>100,000 g mol⁻¹) polyaniline at concentrations exceeding 10 wt. %, which are generally required to produce strong fiber by dry-jet wet spinning techniques, or impact resistant coatings or films by conventional rolling techniques.

There are three principal oxidation states for polyaniline (PANI): (a) the fully oxidized form known as pernigraniline; (b) the intermediate form called emeraldine; and (c) the fully reduced form which is called leucoemeraldine. The general formula describing each of these three primary oxidation states for PANI is:
[(C₆H₄—NH—C₆H₄—NH—)₁₋ₓ][(C₆H₄—N═C₆H₄═N—)ₓ]ₙ, (1)
where x ranges from 0 to 1. When x=1 (pernigraniline), the polymer is in the fully oxidized form and each nitrogen of the polymer repeat unit is a tertiary amine, for example, all are imine nitrogens. When x=0 (leucoemeraldine), the polymer is in the fully reduced oxidation state and every nitrogen of the polymer repeat unit is a secondary amine. However, when x=0.5 (emeraldine), the polymer is in an intermediate oxidation state with equal numbers of amine and imine nitrogens in the polymer repeat unit. The n in structural formula (I) represents the number of repeat units in a given polymer chain at any oxidation state. For many applications, it is desirable to have n be as large as possible.

Emeraldine base {PANI (EB)} polyaniline is the “A-B” base copolymer form of polyaniline and exhibits a nominal four aniline monomer repeat unit. The conductivity (C) of PANI (EB) powders can be adjusted from insulating (σ<10⁻⁸ S/cm) to conducting (σ ˜101 S/cm) by varying the number of protonated imine sites (carriers) through exposure to an equilibrium pH concentration of acid (H⁺A⁻), thereby forming a quaternary emeraldine iminium salt (ES). The average dopant concentration is described by the molar ratio of anions to imine ring nitrogens (y=ANN), where the range of y includes 0.5 (100% doping level), which yields the highest electrically conducting form of the polyaniline emeraldine salt {PANI (ES)} polymer. Although the acid doping process involves no net charge transfer, it profoundly alters the local bond order of the main chain and, simultaneously, the ring torsion of the labile phenylene units. The acid-base chemistry of de-doping and doping polyaniline in the emeraldine oxidation state is shown in FIGS. 1a and 1b.

In order to generate high-quality fibers possessing good mechanical properties, concentrations of a particular polymer in solution should be in the 10-30 wt. % range. Moreover, it is desirable to use the highest molecular weight polymers that will dissolve in solvents in the target concentration range. Tensile strength and modulus, flex life, and impact strength all increase with increasing molecular weight. Typically, molecular weights (M_{w})>120,000 g·mol⁻¹ and (Mₙ)>30,000 g·mol⁻¹ are preferred, since solutions of polyaniline having such molecular weights are suitable for dry-wet or wet fiber spinning processes that produce high-quality fibers, and also for the generation of films, coatings and other useful objects.

It is known that addition of certain salts (preferably lithium chloride) to an aqueous solution of aniline hydrochloride allows the reaction mixture to remain mobile at sub-zero temperatures, while oxidant (preferably ammonium persulfate) is slowly added to the cooled reaction mixture. See, e.g., U.S. Pat. No. 5,837,806 for “Polyanilines And Their Manufacture” which issued to Phillip Norman Adams et al. on Nov. 17, 1998. The resulting polyaniline is of higher molecular weight and contains fewer defect sites than material synthesized at room temperature, since aniline polymerizes by a radical cation mechanism. Defects herein means any structural deformation of the polyaniline linear chain that disrupts the conjugation of alternating single and double bonds, e.g., chain branching, cross-linking, etc. Theoretical studies indicate that such polymerization reactions occur more favorably in a reaction medium having a high dielectric constant (water=80, which is high), and at low temperatures. Addition of salts, such as LiCl, increase the dielectric constant of the reaction mixture still further and allows the mixture to remain mobile at low temperatures. As reaction rates decrease at lower temperatures, it is believed that the aniline polymerizes preferentially in a head-to-tail manner through the para-position. There is less steric hindrance at this location than at the ortho position. This results in a more regular structure. However, if the polymerization is carried out in an acid with large amounts of LiCl present, especially if the acid is HCl, significant ring chlorination occurs (typically 1% by weight of the base polymer is ring-bound chlorine through covalent bond formation). For some applications, it is desirable to eliminate this chlorine and any other impurities/defects that may occur by this route. An example of the adverse effect of chlorine ring substitution is in the application of PANI (ES) thin films as the hole injecting layer for organic light emitting diodes (see A. G. MacDiamid et. al, “Role of ionic species in determining characteristics of polymer LED”, Synthetic Metals, Volume 102, Issues 1-3, Pages 1026-1029 (June 1999)).

The optimum synthesis temperature for aniline in HCl/LiCl solution has been shown to be approximately −25° C. if sufficient persulfate oxidant is added to polymerize all of the aniline. See, e.g., “Low Temperature Synthesis Of High Molecular Weight Polyaniline” by P. N. Adams et al., Polymer 37, 3411 (1996). The resulting weight average molecular weight (M_{w}) is about 1.5×10⁵ g mol¹ in about 95% yield. If LiCl is added to the oxidant solution as well as to the aniline, the temperature can be reduced to −40° C., and only sufficient oxidant may be added to polymerize 40% of the aniline hydrochloride. Moreover, this gives a polymer having a molecular weight of about 2.5×10⁵ g mol⁻¹. If additional oxidant is added, the oxidant reacts with the polyaniline as well as the monomer, giving lower molecular weight material. Moreover, the addition of large amounts of LiCl to the reaction mixture greatly increases the final costs of the polymer since: a) LiCl is an expensive additive; and b) it is difficult to separate from the remaining aqueous HCl reaction mixture thereby increasing the costs associated with hazardous waste removal. It would be advantageous to eliminate the use of LiCl altogether.

Heterogeneous radical chain polymerization of aniline at 0° C. in 1 N aqueous HCl, leads to the acid salt form of polyaniline (See, e.g., A. G. MacDiamid et al., “Conducting Polymers”, Alcacer, L., ed., Riedel Pub., 1986, p. 105, FIG. 1c). When this polyaniline salt powder is immersed in an excess of a strong aqueous base, it is deprotonated to yield EB (See FIG. 1 hereof). Most polyaniline investigations have employed materials having a molecular weight average, (M_{w})<<100,000 g mol¹, and number average, (Mₙ)<<30,000 g mol¹ which are produced by similar synthetic procedures (See, e.g., E. J. Oh et al., “Polyaniline: Dependency Of Selected Properties On Molecular Weight,” Synthetic Metals 55, 977 (1993).

The International Union of Pure and Applied Chemistry (IUPAC) (See, J. Stejskal et al., “Polyaniline. Preparation of a Conducting Polymer”, Pure and Applied Chemistry Vol. 74, No. 5, pp. 857-867, 2002) selected 8 persons from 5 different countries to carry out polymerizations of aniline following the same preparation protocols. These reactions were carried out at room temperature and at 0-2° C. in 0.2 M (regular acidity) and 1.0 M (high acidity) aqueous HCl solutions. Stoichiometric peroxydisulphate oxidant/aniline monomer ratios were adjusted to 1.25 and polymer yields were 90-100%. It was found that there was excellent reproducibility in PANI (ES) and PANI (EB) products generated by the 8 individuals performing the reactions. However, it was reported that: (a) the reduction in reaction temperature had no marked effect on the PANI (ES) conductivity; and (b) elemental composition (as determined by combustion elemental analysis) of the produced PANI (EB) polymers at 0-2° C. contained 2.3% chlorine via partial benzene-ring substitution with chlorine, especially at the higher HCl acid concentrations. There is a need to develop synthetic methods to produce chlorine-free polyaniline.

In U.S. Pat. No. 5,312,686 for “Processable, High Molecular Weight Polyaniline And Fibers Made Therefrom” which issued to Alan G. MacDiamid et al. on May 17, 1994, high-molecular-weight polyaniline was prepared by adding ammonium peroxydisulfate in 1 M HCl to aniline also dissolved in 1 M HCl, with the resulting solution being maintained at below 5° C. The resulting hydrochloride salt may be converted to emeraldine base by treatment with 0.1 M NH₄OH. Low-molecular weight fractions can be removed from the polyaniline base by extraction with solvents such as THF, DMSO, CH₃CN, 80% acetic acid, 60% formic acid, and the like. The resulting extracted polyaniline fraction has a molecular weight greater than 300,000 g mol⁻¹ as determined by Gel-Permeation Chromatography (GPC).

In U.S. Pat. No. 5,519,111 for “High Molecular Weight Polyanilines And Synthetic Methods Therefor,” which issued to Alan G. MacDiamid et al. on May 21, 1996, a procedure for preparing high-molecular-weight polyaniline is reported. The method involves reducing the standard reaction temperature to between −30° C. and −40° C., by adding between 1 and 6 moles/liter of LiCl to the reaction mixture, thereby producing high-molecular-weight EB. Both increasing the concentration of LiCl in the reaction solution as well as lowering the reaction temperature tends to increase the molecular weight of the resulting polyaniline which was found to vary from (M_{w})=250,000 g mol⁻¹ to greater than (M_{w})=400,000 g mol⁻¹ by controlling the initial concentration of the reactants. Maintaining the molar ratio of ammonium peroxydisulfate to aniline monomer constant while diluting their concentration in the HCl was found to increase the molecular weight of the resulting polymer. The high molecular-weight polyanilines produced in accordance with the '111 patent, supra, however, exhibit poor solubility and have short gelation times. Acid doping, followed by dedoping with aqueous base was found to improve solubility in N-Methyl-2-Pyrrolidinone (NMP). This is likely due to the base catalyzed hydrolysis of the initially long polymer chains to shorter units. These solutions were discovered to gel rapidly when prepared in the 1-3 wt. % range. Thus, there exists a need for developing procedures to produce high-molecular-weight polyaniline which is soluble in high concentrations; that is, at >3 wt. %.

European Patent Application, EP-0361429 for “Organic Polymer, Conducting Organic Polymer, Production Methods And Uses Of The Same” by Masao Abe et al., teaches that oxidizing agents should be added dropwise to avoid the temperature of the reaction mixture rising above 5 C wherein polymer having low-molecular weight would be generated.

European Patent Application, EP-0605877 for “Method For Preparing Polyaniline” by Hannele Jarvinen et al. teaches the control of the molecular weight of the polyaniline product by either adding a solution of HCl and oxidizing agent to a reaction vessel containing aniline, or adding the oxidizing agent to a solution of HCl.

U.S. Pat. No. 5,008,041 for “Preparation Of Conductive Polyaniline Having Controlled Molecular Weight” which issued to Randy E. Cameron and Sandra K. Clement on Apr. 16, 1991 teaches the oxidation of a mixture of aniline and dianiline in predetermined proportions to achieve high molecular weights.

The preponderance of patent or scientific literature regarding polyaniline synthesis in aqueous media report synthetic conditions whereby the concentration of the acid is measurable on the pH scale and the acid most frequently reported is HCl. The activity and concentration of the hydronium ion are obtained by measurements of pH by ion selective electrodes or pH paper containing indicators. However, such measurements are valid only in single solvent systems, typically water, for very dilute concentrations of an acid. In very concentrated acid solutions, in mixed acid solutions, or in non-aqueous solutions, a measure of the ability of an acid to dissociate a proton from an indicator, according to HB⁺ [symbol] H⁺+B, is the Hammett acidity function, Hₒ given by:

$${H}_{o} = {pK}_{{HB}^{+}} - log \frac{{c}_{{HB}^{+}}}{{c}_{B}} , where \qquad Eq . 2$$

c_{HB}⁺ and c_{B} are the concentrations of the two forms of a protonated and non-protonated indicator, respectively, in an equilibrium mixture (See, for example, Acidity Functions by Colin H. Rochester, Academic Press (1970).). Indicator compounds used to determine the Hammett Acidity Function (Hₒ) include aniline, or more commonly, substituted anilines such as p-nitroaniline. Once Hₒ is determined, Equation 2 can be used directly, in a similar manner to pH, to obtain unknown acidity constants from ionization ratio measurements; that is: pK_{HB}⁺=Hₒ+log [c_{HB}⁺/c_{B}]. Concentrations of HB⁺ and B are measurable by spectroscopy, and pKₐ values of the acids HB⁺ are well known.

Hammett acidity function, Hₒ, scales are useful for comparing different acid media for acid strength. As an example, a solvent system containing 60 wt % of H₂SO₄ in water has a Hₒ value of −4.32 at 25° C. A useful indicator base for determining this value is 2,4-dinitroaniline (pK_{HB}⁺=−4.38).

In order to determine the extent to which the freezing point of a solution can be depressed, it is important to know the “molal freezing point depression constant”. This is the amount by which the freezing point changes for each mole of solute that is added to a kilogram of the solution. Ionized solutes are counted as having one mole for each ion that is formed upon dissociation; that is, NaCl counts as “two moles”, while sucrose, which doesn't ionize, counts as only one. For water, the freezing point depression is 1.86 degrees Kelvin per mole of solute.

Accordingly, it is an object of the present invention to prepare substantially chlorine-free, high molecular weight polyaniline, ring-substituted polyaniline, and polyaniline co-polymers.

Another object of the invention is to prepare substantially defect-free, high-molecular-weight polyaniline, ring-substituted polyaniline, and polyaniline co-polymer.

Yet another object of the present invention is to prepare high molecular weight polyaniline at low temperatures in the absence of freezing-point-lowering salts in the reacting mixture.

Yet another object of the present invention is to prepare substantially defect-free, high molecular weight polyaniline, ring-substituted polyaniline, and polyaniline co-polymer by increasing the rate of acid catalysis of the polymer chain propagation step by increasing the acid concentration in the reaction mixture to levels such that the acid activity is measured by the Hammett Acidity Function (Hₒ).

Still another object of the invention is to prepare polyaniline having a chosen molecular weight.

Additional objects, advantages and novel features of the invention will be set forth, in part, in the description that follows, and, in part, will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects of the present invention, and in accordance with its purposes, as embodied and broadly described herein, the method for preparing chlorine-free polyaniline having a chosen molecular weight hereof includes: forming a reactive mixture at reaction temperatures below about 273 K comprising aniline monomer, a free-radical initiating oxidant, and an effective amount of non-chlorinated acid having a Hammett Acidity Function less than about 0.5 for keeping the reactive mixture from freezing in the absence of a freezing point depressing salt; and maintaining the reactive mixture at a temperature such that the chosen polyaniline molecular weight is achieved.

In another object of the present invention in accordance with its objects and purposes, the method for preparing chlorine-free polyaniline having a chosen molecular weight hereof includes: forming a reactive mixture at reaction temperatures ranging between about 223 K and about 273 K comprising aniline monomer, a free-radical initiating oxidant, and an effective amount of non-chlorinated acid for keeping the reactive mixture from freezing in the absence of a freezing point depressing salt, and for protonating the aniline monomer; and maintaining the reactive mixture at a temperature such that the chosen polyaniline molecular weight is achieved.

In yet another object of the present invention in accordance with its objects and purposes the reactive mixture suitable for preparing chlorine-free polyaniline having a chosen molecular weight at reaction temperatures below about 273 K in the absence of a freezing point depressing salt hereof includes: aniline monomer, a free-radical initiating oxidant, and a non-chlorinated acid having a Hammett Acidity Function less than about 0.5 and effective for preventing the reactive mixture from freezing.

In still another object of the present invention in accordance with its objects and purposes, the mixture suitable for preparing chlorine-free polyaniline having a chosen molecular weight at reaction temperatures below about 273 K in the absence of a freezing point depressing salt hereof includes: aniline monomer, a free-radical initiating oxidant, and a non-chlorinated acid effective for preventing the reactive mixture from freezing and for protonating the aniline monomer.

Benefits and advantages of the present method include the preparation of substantially defect-free and chlorine-free polyaniline having a chosen molecular weight without the requirement of using salts to prevent freezing of reaction mixtures during low-temperature batch or continuous-flow syntheses.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 shows the reversible nature of forming emeraldine base {PANI (EB)} polyaniline, or emeraldine salt {PANI (ES)} polyaniline.

FIG. 2 is a graph of the freezing-point depression of water as a function of increasing sulfuric acid concentration.

FIG. 3 is a graph of the freezing-point depression of water as a function of increasing phosphoric acid concentration.

FIG. 4a is a graph of the weight-average molecular weight polyaniline {PANI (EB)} as a function of sulfuric acid concentration in the reaction mixture, while FIG. 4b is a graph of the polyaniline {PANI (EB)} reduced viscosity as a function of sulfuric acid concentration in the reaction mixture, where the polyaniline was prepared in accordance with the teachings of the present invention.

FIG. 5a is a graph of the weight-average molecular weight and the reduced viscosity for polyaniline {PANI (EB)} as a function of the sulfuric acid Hammett acidity function for the reacting mixture, while FIG. 5b is a graph of the average molecular weight and the reduced viscosity for polyaniline {PANI (EB)} as a function of sulfuric acid concentration, where the polyaniline was prepared in accordance with the teachings of the present invention.

FIG. 6a is a graph showing the relationship between the weight-average molecular weight of polyaniline {PANI (EB)} and the inverse of the reaction temperature, while FIG. 6b shows the relationship between the reduced viscosity of polyaniline {PANI (EB)} and the inverse of the reaction temperature, where the polyaniline was prepared in accordance with the teachings of the present invention.

FIG. 7 is a graph showing the relationship between the reduced viscosity and the weight average molecular weight as determined by gel permeation chromatography for polyaniline {PANI (EB)} made in accordance with the teachings of the present invention.

FIG. 8 is a graph of the weight-average molecular weight of polyaniline {PANI (EB)}, as a function of the temperature of a phosphoric acid reaction mixture having a constant Hammett Acidity Function (Hₒ=−1.66), showing an increase in average molecular weight with decreasing temperature to a maximum value of 475,000 g mol⁻¹ at 243 K, and an approximately linear decrease thereafter with decreasing temperature, for polyaniline made in accordance with the teachings of the present invention.

FIG. 9 is a graph of the weight-average molecular weight of polyaniline {PANI (EB)} as a function of reaction temperature for a phosphoric acid reaction mix, the Hammett Acidity Function being kept constant at Hₒ=−0.94.

FIG. 10 is a graph of the weight-average molecular weight of polyaniline {PANI (EB)} as a function of oxidant addition time for reaction mixtures containing phosphoric acid, for polyaniline made in accordance with the teachings of the present invention.

### DETAILED DESCRIPTION

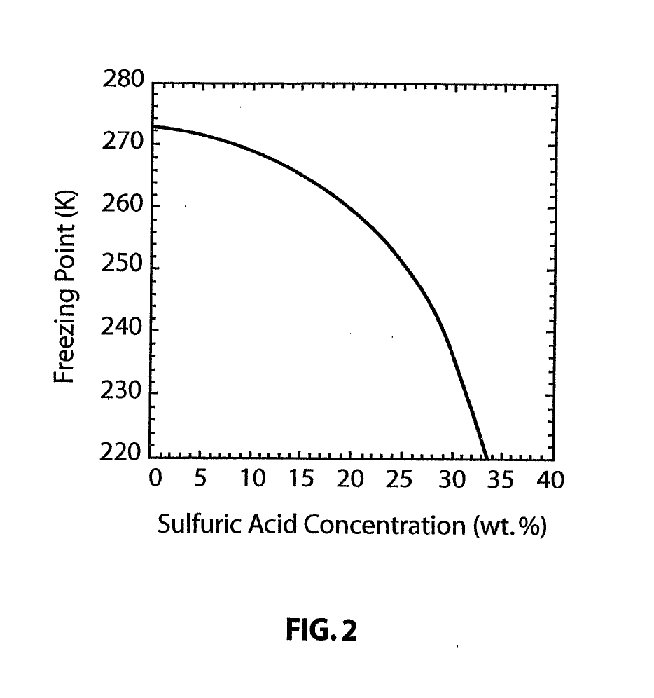

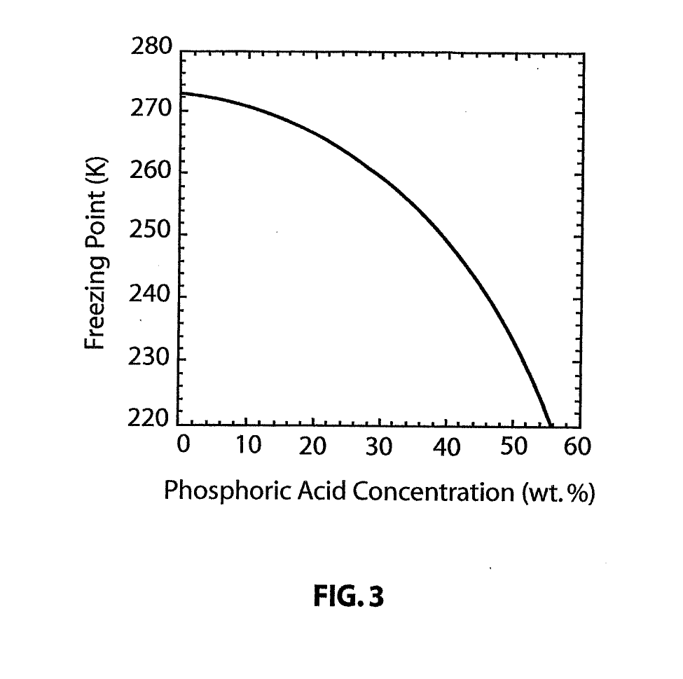

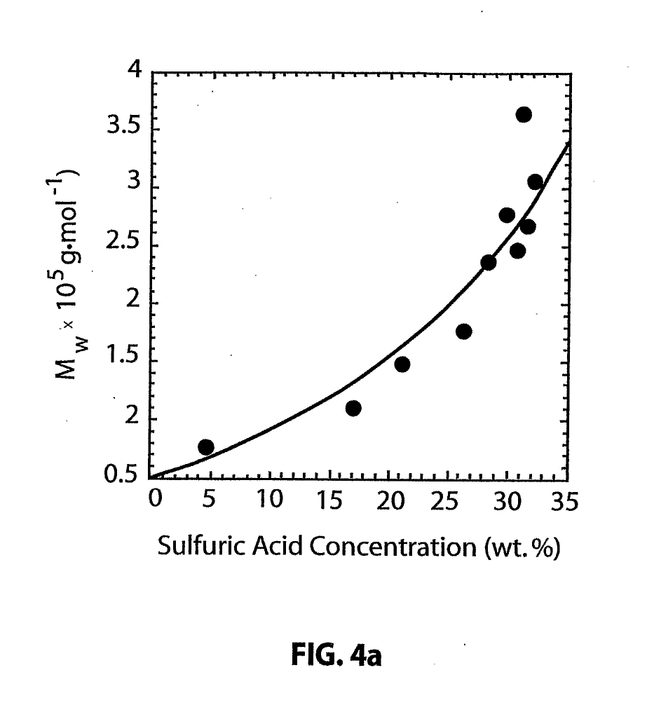

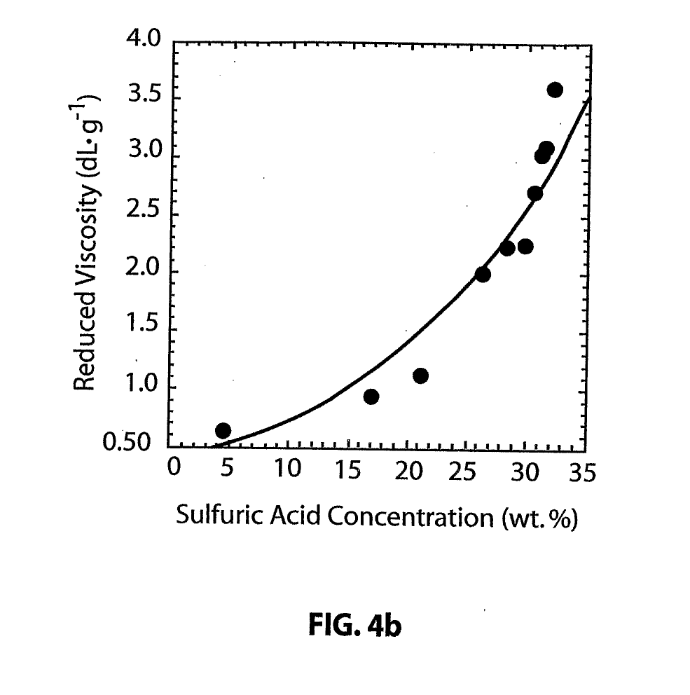

Briefly, the present invention includes methods for preparing substantially defect-free, adjustable molecular-weight, aniline-based polymers at sub-ambient temperatures in the absence of salts for lowering the freezing point of the reacting solutions, and in the absence of inorganic acids containing chlorine atoms. Generally, batch reactions were performed at between 0° C. (273 K) and −50° C. (223 K) by adding an oxidant effective for causing polymerization at a chosen rate to a cold mixture of aniline and a suitable acid. Continuous feed reactions were performed by adding the oxidant and the acidified aniline to a reactor at a chosen rate in a cooled reaction vessel, and removing the reacted materials after a chosen time. Acid concentrations and types were chosen such that the reaction mixture remained fluid at low temperatures, while the resulting polymer was not significantly degraded by the presence of the acid. Typically, the Hammett acidity functions for the reacting mixtures were in the range: −2 H₀ 0.5. Molecular weight of the resulting polyaniline was found to be adjustable by (a) choosing the rate of addition of the oxidant to the reaction mixture for batch processing; (b) choosing the temperature of the reaction (see for example FIG. 2 and FIG. 3 hereof); (c) choosing the contact time of the reactants for processing in a continuous system; and/or (d) decreasing the Hₒ of the acid solution from a positive to a negative value, e.g.; increasing the weight percent of the acid in the reaction mixture (See FIG. 4a and FIG. 4b hereof).

The term “polyaniline polymer” as used herein, means the polymerization reaction product resulting from the oxidation of the protonated aniline monomer and the formation of head-to-tail bonds between the oxidized monomers which may be in the form of insoluble solid precipitates, suspensions, or solutions in the reaction mixture having low or high molecular weight. Further, the terms “dopant”, “doped” and variations thereof, as used herein, all refer to the formation of an electronically-conductive complex of a protonated polyaniline polymer and a suitable anion and may have monomeric or polymeric dopants or a mixture thereof.

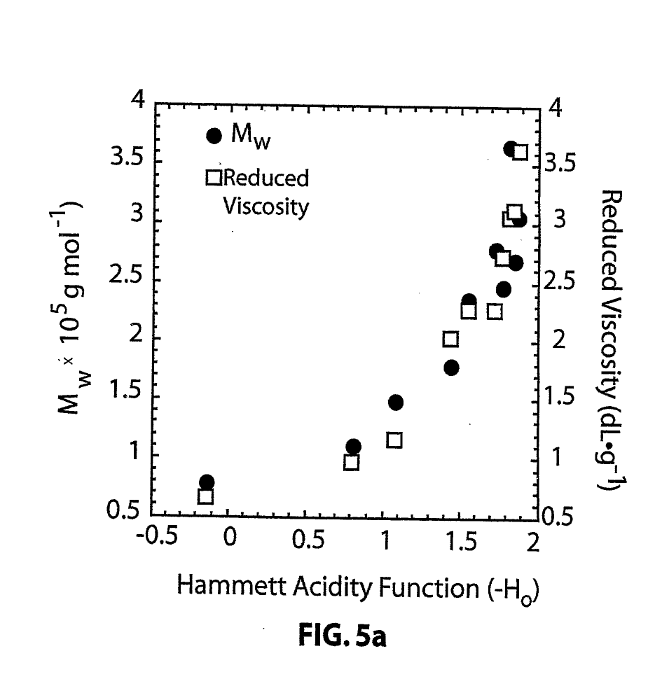

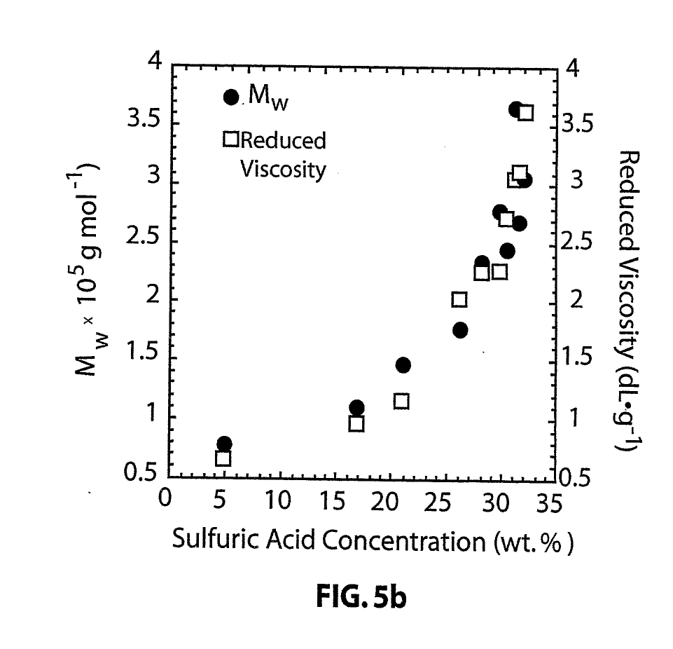

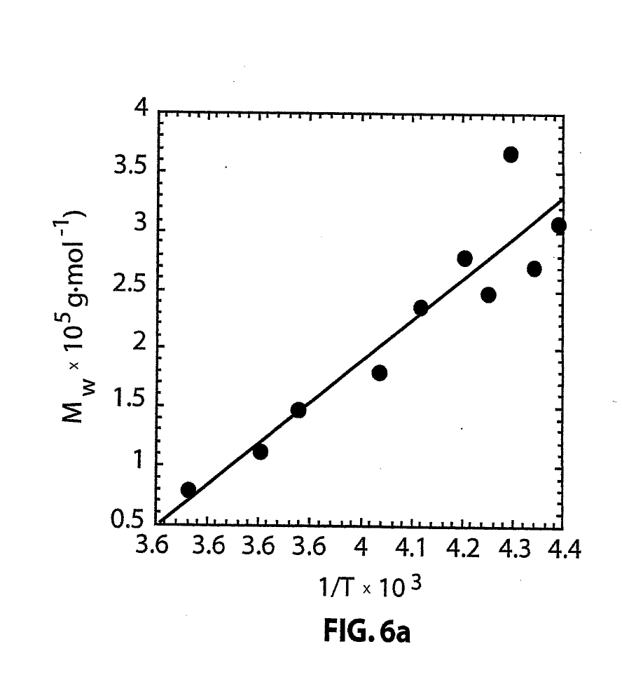

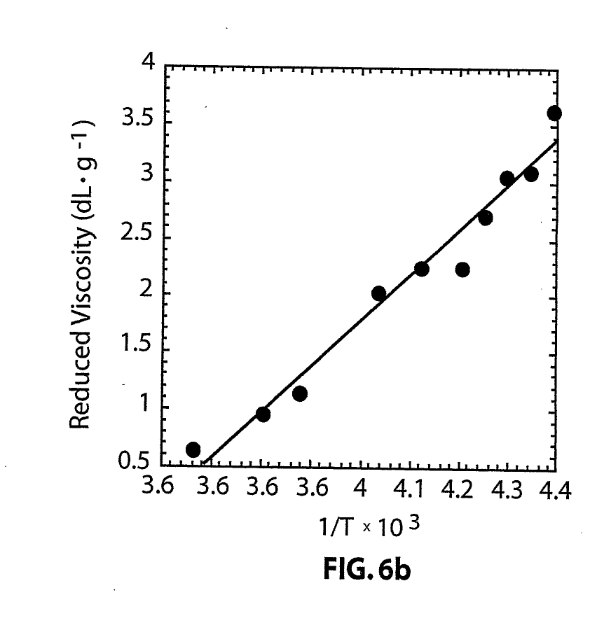

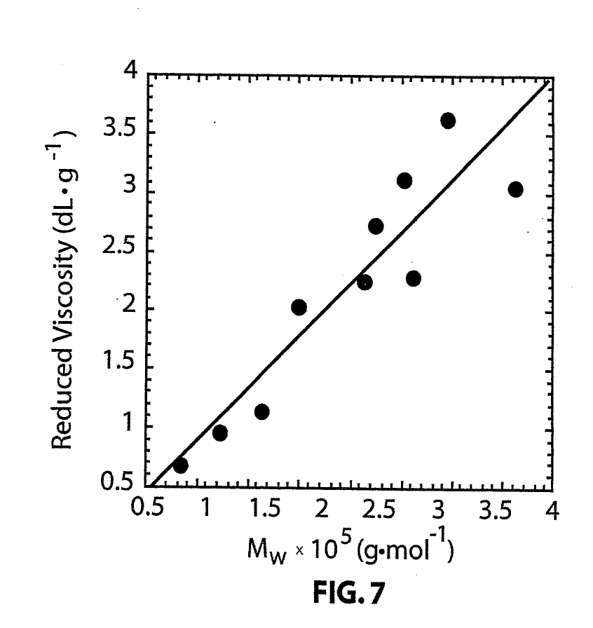

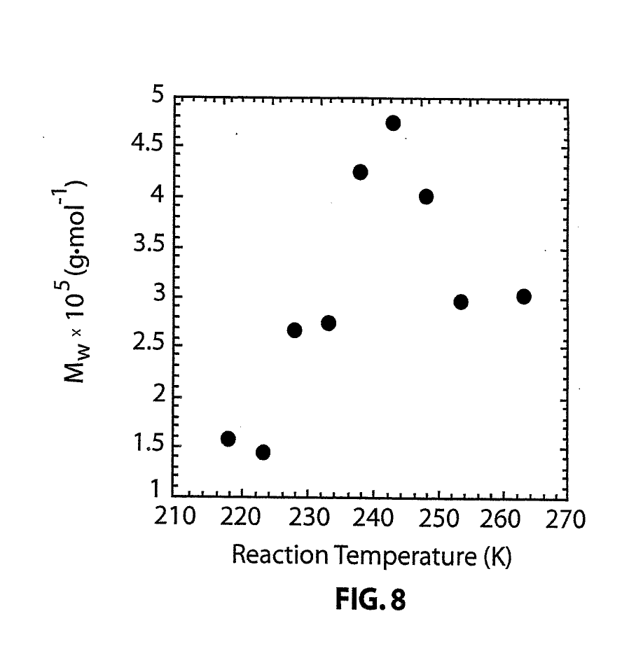

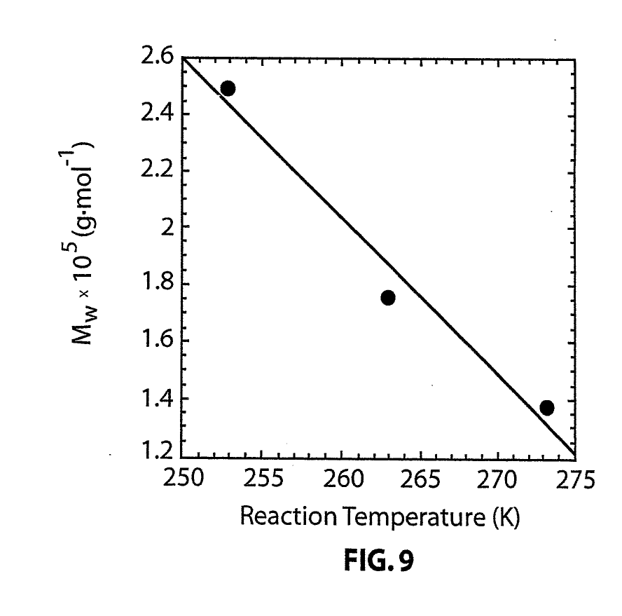

There are at least three stages to the growth of polyaniline chains during the acid catalyzed oxidative polymerization: (a) initiation; (b) chain growth; (c) and termination. Without being limited by the theory of the actual acid catalyzed polymerization mechanism of aniline, the benefits derived from carrying out the reactions in highly acidic media are: (a) control of the resulting molecular weight: and (b) the minimization of structural defects. Highly acidic reaction media improves the kinetics of the chain propagation and growth step of the growing PANI (ES) macromolecule. The benefits to the reactions in concentrated sulfuric acid are seen in FIG. 5a and FIG. 5b, which show that the molecular weight of the resulting PANI is directly correlated with both sulfuric acid concentration (wt. %) and its corresponding Hammett Acidity Function (Hₒ). Protonation of the aniline monomer to form the anilinium cation is the first step of this acid catalyzed reaction. The extent to which the aniline monomer substrate is protonated influences the reaction rate, and by Le Chatelier's principal, the higher the acid concentration, the greater the extent to which both the monomer and the polymer growing chain are protonated. In other words, it is desirable in accordance with the present invention that the [H₃O⁺] concentration be increased to increase the degree of substrate protonation, thereby enhancing the reaction rate for a growing polymer chain at a given sub-ambient temperature. Controlling the temperature of the reaction in the highly acidic media allows for the control of the reaction rate of the chain propagation stage, with lower temperatures resulting in higher weight average (or viscosity average) molecular weights of the produced polymer as shown in FIG. 6a and FIG. 6b for sulfuric acid, and FIG. 8 and FIG. 9 for phosphoric acid. The final PANI (EB) molecular weight is seen to be inversely proportional to the polymerization temperature. In accordance with the present invention, molecular weights can be selected by: (a) simultaneously varying both Hₒ and T in a systematic manner; (b) holding Hₒ constant and varying T; or (c) holding T constant and varying Hₒ. The correlations found between the two methods of measuring PANI (EB) molecular weight, i.e., reduced viscosity and gel-permeation chromatography data, are good as shown in FIG. 7.

An acidic medium is required to form the conductive complex, although the anionic portion thereof may be derived from the salt of an acid. “Dopant acid,” as used herein, refers to an acid which not only protonates the polyaniline polymer, but also provides the anion which forms part of the conductive complex. The terms “protonated derivative” and “protonate,” as used herein, refer to contacting the aniline monomer with an acid under conditions whereby the corresponding anilinium cation is formed, or to contacting the polyaniline polymer with an acid under conditions whereby a radical cation is formed from the polymer. Treatment or purification of the protonated aniline monomers prior to polymerization is not required. If the Lewis acid used to protonate the aniline monomer is polymeric (such as polyphosphoric acid, as an example), the acid may form a complex with the aniline monomer(s).

Important processing variables include: (a) reaction temperature; (b) pressure; (c) total reaction time; (d) aniline monomer concentration; (e) choice of acid(s); (f) acid concentration; (g) conversion of aniline monomer; (h) amount of oxidant added; (i) oxidant addition rate; and (j) amount of acid used. Choices for these variables depend on the desired properties for the polyaniline polymer, such as (i) molecular weight; (ii) conductivity; and (iii) solubility. For example, adding a particular Lewis acid to the reaction mixture so that such acid will be the dopant acid for the resulting polyaniline polymer, may result in improved solubility or melt-processing characteristics of the polymer. However, routine experimentation may be required to determine the best process conditions for a particular combination of aniline monomer and dopant acid.

In accordance with the teachings of the present invention, the polymerization reaction is carried out at temperatures between about 273 K and about 223 K such that the desired extent of reaction may be obtained in a time period between 4 h and 50 h. Except for the addition of the oxidant, the order of addition of reactants is not critical. However, if a polymeric dopant acid is added to the reaction mixture, it may be preferable that the dopant be complexed with the aniline monomer prior to the addition of the other reactants.

Reference herein to “contacting” aniline monomers in the presence of certain components of the reaction mixture shall mean that: (a) the recited component is added to the reaction mixture; (b) the recited component is formed in the reaction mixture in situ; (c) the recited component reacts or complexes with other components of the reaction mixture or the aniline monomer prior to the formation of polyaniline polymer; or (d) any combination of (a)-(c) occurs. The reaction products, combinations or subcombinations of a group of components, including compounds, salts, and complexes which may be formed by contacting the acid, oxidant, and aniline monomers, are included within the definition of a particular reaction mixture component, unless otherwise stated herein.

Sufficient oxidant is added to the mixture to react between 30% and 99% of the aniline. Although higher conversion of aniline monomers is generally desirable from a cost standpoint, high conversion may occasionally result in a decline in the quality of the product obtained. The progress of the reaction can be followed by gas chromatography or by other means that will quantify the amount of aniline remaining. If the conversion of aniline is not as high as desired, additional oxidant may be added at any time. The polyaniline product is removed from the reaction mixture as soon as possible once the desired conversion has been attained in order to prevent the hydrolysis of the polyaniline which may reduce its molecular weight and its conductivity. If the polyaniline polymer is insoluble in the reaction mixture, removal thereof includes filtration and washing of the solid with at least 50 mL of water for every gram of reaction product, followed by washing with between about 2 and about 20 mL of methanol or isopropanol per gram of reaction product. Since the reactants are separated from the product for this situation, the reaction is effectively terminated. In the event that the polyaniline polymer is soluble in the reaction mixture, this separation is not achieved, and the reaction will continue until the oxidant is depleted or otherwise inactivated. The amount of oxidant added to the reaction mixture is controlled so that the oxidant is substantially consumed when the desired conversion of aniline monomer has been achieved.

The term “aniline monomers” as used herein means unsubstituted, substituted or multiply substituted aniline monomers where H, D or alkyl may be used to replace the amine hydrogen or hydrogens, and the ring hydrogens may be replaced by any of H, D, alkyl, hydroxyl, alkenyl, alkoxy, alkoxyalkyl, cycloalkyl, cycloalkenyl, alkanoyl, alkylthio, aryloxyalkylthioalkyl, alkylaryl, arylalkyl, amino, alkylamino, dialkylamino, aryl, arylamino, diarylamino, alkylarylamino, alkylsulfinyl, alkylsulfinylalkyl, aryloxyalkyl, alkylsulfonyl, arylthio, arylsulfinyl, alkoxycarbonyl, arylsulfonyl, carboxylic acid, sulfonic acid, halogen, cyano, or alkyl substituted with one or more sulfonic acid, carboxylic acid, halo, nitro, cyano, or epoxy group; or any two R groups together may form an alkene or alkenylene chain completing a 3, 4, 5, or 6-membered aromatic or alicyclic ring, which ring may optionally include one or more divalent nitrogen, oxygen, or sulfur atoms, or boric, phosphoric, carboxylic, phosphonic, sulfinic, phosphinic, and sulfonic acids, salts or esters thereof, and their protonated derivatives. Preferably, any alkyl or alkylene substituents of the above-named groups contain less than 50 carbon atoms.

The total amount of aniline monomer added to the polymerization reaction mixture is chosen to be between 0.3 moles of aniline monomer unit per liter of reaction volume and 2 moles per liter.

Aniline monomers generally have low solubility in water; however formation of protonated derivatives thereof or complexes with Lewis acids greatly increases its solubility. The number of moles of Lewis acid in the reaction mixture is also chosen to be greater than the number of moles of aniline monomer at all times during the reaction, such that an initial excess proton concentration (over the amount which protonates or complexes with the aniline monomer) of between 0.1 molar and 5 molar is maintained. Lewis acids suitable for use in the processes of the invention include acids which will protonate or form a complex with the aniline monomer to provide sufficient solubility in the polymerization reaction mixture to permit the polymerization to proceed, while not attacking the monomer or polymer. Examples of suitable acids include, but are not limited to sulfuric, benzoic, n-Butyric, chromic, hydrofluoric, iodic, acetic, formic, trifluoroacetic, periodic, octanoic, picric, nitric, nitrous, trifluoromethanesulfonic, benzenesulfonic, substituted benzenesulfonic, toluenesulfonic, dodecylbenzenesulfonic, 10-camphorsulfonic, polystyrene sulfonic, o-phosphoric, o-phosphorous, polyphosphoric, orthophosphoric, hydrogen selenide, hydrogen telluride, sulfanilic, and polyacrylic acids, and mixtures thereof. Concentrations of these acids are selected such that the reacting mixtures do not freeze, and such that the Hammett Acidity Functions for the mixtures are greater than about −2 and less than about 0.5.

Mixtures of Lewis acids may also be employed according to the teachings of the invention. If the process employs a chosen acid as the principal source of acid in the reaction mixture and the desired dopant acid is a different Lewis acid, the dopant acid may be added to the polymerization reaction mixture in addition to the principal acid.

The reaction mixture generally contains water or an organic solvent which functions to dissolve the reactants and serve as a reaction medium, the water or solvent being present in amounts sufficient to provide the desired concentration of reactants described elsewhere herein. The reaction mixture may be a single phase (except for precipitated polyaniline polymer), or an emulsion polymerization or interfacial process, if desired.

The average molecular weight of the polyaniline polymer obtained by the processes described herein is generally greater than 50,000 g mol⁻¹. If the polyaniline polymer is insoluble in the reaction mixture, molecular weights represent the average molecular weight of the precipitated polymer.

Two types of oxidants have been found to cause polymerization in aniline at low temperatures; persulfates and dichromates.

The conductivity of the polyaniline polymer obtained by the processes described herein were found to be between <10⁻⁸ Siemens/cm (S/cm) and 15 S/cm, as measured by 4-Point Probe conductivity measurements of the compressed polymer powder pellets. Conductivities of the polyaniline polymer can be determined as follows: (a) the polymer is first isolated from the polymerization reaction and dried overnight under dynamic vacuum at 45° C.; the solid PANI (ES) powder is pressed at 700 MPa to form a pellet; (c) two opposing surfaces are painted with a conductive primer; (d) the resistance is measured from one face to the opposite face of the sample; and (e) the conductivity is calculated by dividing the distance between the two painted surfaces (typically about 0.1-1 mm, but measured for each sample) by the area of the painted surface (typically 1 cm²) and by the resistance in ohms to yield the conductivity in S/cm.

The molecular weight of the polyaniline (emeraldine base) powders produced in accordance with the teachings of the present invention were determined by reduced viscosity measurements in which the polymer is dissolved in sulfuric acid, or by gel permeation chromatography using polystyrene standards, in which the polyaniline is dissolved in a polar aprotic solvent such as N-methyl-2-pyrrolidinone. An ionic salt is added to prevent aggregation of the polyaniline chains; otherwise, a non-Gaussian molecular weight distribution is observed. Typically ionic salts used to deaggregate polyaniline include lithium and ammonium salts, such as lithium chloride, lithium bromide, lithium tetrafluoroborate, and lithium formate. With an ionic salt in the eluent, the polyanilines of the present invention exhibit single-peak gel permeating chromatograms. The polydispersity of a polymer is defined as the ratio of its weight-average molecular weight to its number-average molecular weight (i.e. M_{w}/Mₙ). The polydispersity and the molecular weight of polyaniline have a pronounced effect on its physical properties such as tensile strength, modulus, and impact strength (toughness). Lower polydispersity values are generally indicative of a more controlled polymerization process and a higher quality polymer. Due to the Gaussian distribution of molecular weights, the peak molecular weight (Mₚ) values are also reported; that is, the molecular weights corresponding to the maximum intensity in the gel permeation chromatogram.

Having generally described the invention, the following Examples provide additional details.

A. Preparation of Polyaniline (Emeraldine Base) in Sulfuric Acid

### EXAMPLES 1-10

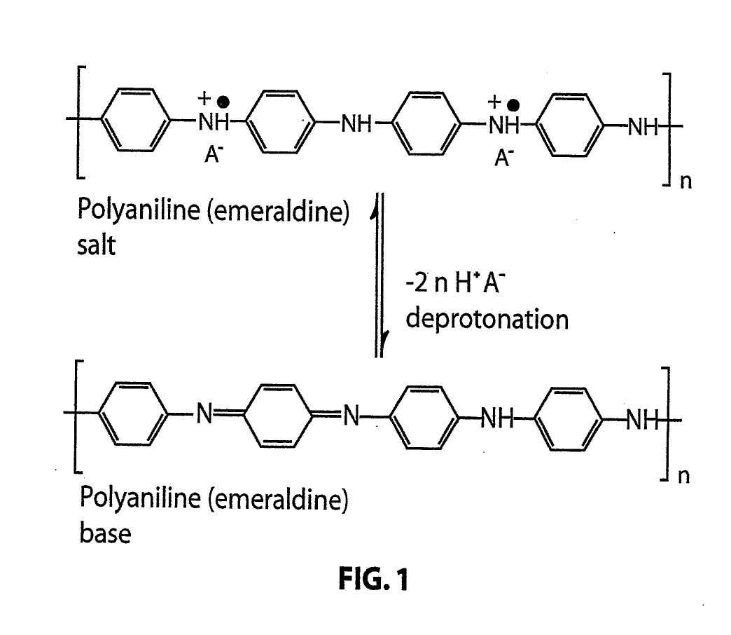

Reactions were performed at temperatures between about 273 K and about 228 K, using an amount of sulfuric acid effective to prevent the mixture freezing at the chosen reaction temperature. A freshly prepared solution of 0.1 moles of aniline (9.31 g) dissolved in 100 g of sulfuric acid, as shown in TABLE 1. FIG. 1 is a graph of the freezing point for aqueous sulfuric acid, from which it can be seen that using sulfuric acid solutions as the reaction medium allows temperatures as low as 232 K to be attained without the reaction mixture freezing, and without the use of freezing point lowering salts such as LiCl. The Hammett acidity values for the sulfuric acid solutions listed in TABLE 1 were estimated from values reported in literature. As stated hereinabove, the Hammett Acidity Function is used as a measure of the acid strength for the high concentrations and low temperatures, where pH measurements are not possible.

The solution containing the aniline monomer was placed in a 1 L reaction vessel having a thermally insulated lid and a stirrer paddle, and placed in a temperature-controlled bath. A solution of 0.125 moles of ammonium persulfate (28.52 g) was dissolved in 80 g of water. A peristaltic pump running at 0.15 g/min was used to add the oxidant solution to the reaction mixture over a period of 9 h. The total reaction time was 20 h during which time, the reaction vessel was kept in the temperature-controlled cooling bath at a chosen set temperature for the entire reaction period. The polyaniline slurry inside the reaction vessel was then filtered and washed with several liters of water until a colorless filtrate was obtained. The filter cake was subsequently deprotonated by mixing it with 200 ml of a 2% NaOH solution and stirring for 1 h. The suspension was refiltered, rewashed with several liters of water until a colorless filtrate was obtained (with a final wash of 2-propanol), and then dried under vacuum at about 343 K for 20 h. The dried emeraldine base powder was weighed, and a percent yield calculated based on the amount of aniline starting material.

TABLE 1

| | Reaction | H₂SO₄ | | |
|---|---|---|---|---|
| Example | Temperature | Conc. | H₀ at | |
| No. | (K) | (wt %) | 298 K | % yield |
| 1 | 273 | 4.5 | 0.13 | 93 |
| 2 | 263 | 16.9 | −0.80 | 94 |
| 3 | 258 | 21.0 | −1.08 | 97 |
| 4 | 248 | 26.2 | −1.44 | 98 |
| 5 | 243 | 28.2 | −1.55 | 94 |
| 6 | 238 | 29.8 | −1.72 | 95 |
| 7 | 235.5 | 30.5 | −1.76 | 95 |
| 8 | 233 | 31.1 | −1.81 | 100 |
| 9 | 230.5 | 31.5 | −1.84 | 100 |
| 10 | 228 | 32.0 | −1.87 | 95 |

The molecular weight of each polymer sample was characterized using gel permeation chromatography (GPC) by first dissolving the sample in N-methyl-2-pyrrolidinone solvent (NMP, containing 0.02-0.1 wt % of an ionic salt, such as lithium chloride, lithium formate, lithium tetrafluoroborate, or ammonium formate) forming a 0.02 wt % solution. Each solution was in turn passed through a Waters Styragel® HR5E column using a Waters 2690 pump at a flow rate of 1 ml/min or through a combination of a Waters Styragel® HR 4E column and a Waters Styragel® HR5E column in series, with a flowrate of 0.35 ml/min. Column temperatures were maintained either at 323 K or 333 K. A Waters 410 Refractive Index Detector, kept at 323 K, and a Waters 996 Photodiode Array Detector were both used to monitor the change in concentration of the mass fractions as they emerged from the column, producing similar results as far as the molecular masses that were measured. The columns were calibrated using Easical polystyrene molecular weight standards from Polymer Laboratories. Both the polystyrene standards and the polyaniline solutions were filtered through a 0.45 μm micropore syringe filter prior to being injected into the columns.

The molecular weight of the emeraldine base was also characterized using reduced viscosity (η_{red}). The molecular weights were measured by dissolving the polyaniline sample in 95% sulfuric acid at 298 K to give 0.1 wt % solutions. A Brookfield RVDV-III cone and plate viscometer was used to obtain viscosity values (plate diameter=40 mm, spindle angle=80, rotation speed=10 rpm, solution volume=0.5 ml.).

The molecular weights of the emeraldine base powders synthesized in sulfuric acid are summarized in TABLE 2. The results show a gradual increase in reduced viscosity and molecular weight with decreasing reaction temperature and/or Hammett Acidity Function. Reactions at temperatures lower than about 228 K could not be carried out, although it is expected by the present inventors that a reaction would occur at temperatures as low as 223 K.

TABLE 2

| Example | η_{red}* | Mₚ | M_{w} | Mₙ | |
|---|---|---|---|---|---|
| No. | (dlg⁻¹) | (g/mol) | (g/mol) | (g/mol) | M_{w}/Mₙ |
| 1 | 0.66 | 67,800 | 77,500 | 25,700 | 3.0 |
| 2 | 0.96 | 91,200 | 111,000 | 30,500 | 3.6 |
| 3 | 1.16 | 107,000 | 148,000 | 38,900 | 3.8 |
| 4 | 2.03 | 155,000 | 178,000 | 56,400 | 3.2 |
| 5 | 2.26 | 200,000 | 235,000 | 64,000 | 3.7 |
| 6 | 2.27 | 229,000 | 278,000 | 65,500 | 4.2 |
| 7 | 2.72 | 207,000 | 246,000 | 56,400 | 4.4 |
| 8 | 3.05 | 227,000 | 366,000 | 65,800 | 5.5 |
| 9 | 3.11 | 219,000 | 269,000 | 69,000 | 3.9 |
| 10 | 3.63 | 233,000 | 307,000 | 67,000 | 4.6 |

B. Preparation of Polyaniline (Emeraldine Base) in Phosphoric Acid

### EXAMPLES 11-19

Various acid concentrations in the reaction medium and reaction temperatures were used for the synthesis of polyaniline. In general, the molecular weight increases with decreasing temperature, so reactions are often carried out at sub-zero temperatures if high molecular weight material is required. In order to stop the reaction mixture from freezing, it is normal to increase the acid concentration. FIG. 2 is a graph of the freezing point for aqueous phosphoric acid, from which it can be seen that using phosphoric acid solutions as the reaction medium allows temperatures as low as 218 K to be attained without the reaction mixture freezing, and without the use of salts.

A similar series of reactions to those described in Examples 1-10 were carried out in 60% phosphoric acid solution at temperatures between about 263 K and about 218 K. A solution of 1.0 moles of aniline (93.13 g) in 1 kg of 60% phosphoric acid is freshly prepared. The Hammett Acidity Function for 60 wt % phosphoric acid is −1.66 at 298 K. The reactions were performed at different temperatures between 263 K and 218 K as shown in TABLE 3. The aniline solution was placed inside a 3 L jacketed reaction vessel fitted with a mechanical stirrer and cooled to the desired reaction temperature by passing a chilled 50/50 by mass, methanol/water mixture through the vessel jacket. The oxidant, ammonium persulfate (1.25 moles, 285.2 g) was dissolved in water (800 g), and the resulting solution was added to the cooled, stirred reaction mixture using a peristaltic pump at a constant rate over a 40 h period. The total reaction time was between 43 h and 46 h, with the only exception being the polyaniline powder synthesized at 218 K. For this example, the total reaction time was 90 h due to the slower reaction kinetics.

After the reaction, the contents of the reaction vessel were filtered, and washed with water. The filter cake was subsequently deprotonated by adding 200 ml of a 2% NaOH solution, the suspension was refiltered, rewashed (with a final wash of 2-propanol) and then dried under vacuum at 343 K for 20 h. The dried emeraldine base powder was weighed and a percent yield calculated, based on the amount of aniline starting material.

The molecular weights of these polyaniline powders were characterized using gel permeation chromatography (GPC) as described for EXAMPLES 1-10 hereinabove, and summarized in TABLE 3.

TABLE 3

| | Reaction | | | | | |
|---|---|---|---|---|---|---|
| Example | Temperature | Yield | Mₚ | M_{w} | Mₙ | |
| No. | (K) | (%) | (g/mol) | (g/mol) | (g/mol) | M_{w}/Mₙ |
| 11 | 263 | 94.7 | 159,000 | 302,000 | 29,000 | 10.4 |
| 12 | 253 | 95.6 | 157,000 | 296,000 | 29,300 | 10.1 |
| 13 | 248 | 94.1 | 206,000 | 403,000 | 50,000 | 8.1 |
| 14 | 243 | 96.2 | 203,000 | 475,000 | 52,400 | 9.0 |
| 15 | 238 | 96.7 | 206,000 | 426,000 | 75,500 | 5.6 |
| 16 | 233 | 95.1 | 130,000 | 273,000 | 33,700 | 8.1 |
| 17 | 228 | 93.9 | 136,000 | 267,000 | 34,600 | 7.7 |
| 18 | 223 | N/A | 83,600 | 145,000 | 17,400 | 8.3 |
| 19 | 218 | 86.4 | 87,500 | 158,000 | 21,500 | 7.3 |

### EXAMPLES 20-22

A similar series of reactions to those described in Examples 11-19 were carried out in 45% phosphoric acid solution in a 50 liter jacketed reaction vessel at different temperatures between 273 K and 253 K. The lower phosphoric acid concentration in the reaction medium means that Hammett Acidity Function of the reaction medium is −0.94 at 298 K. Water (3,760 g) was first added to a 50 L jacketed reaction vessel fitted with a mechanical stirrer. Phosphoric acid (85%; 4,240 g) was then added to the water, with stirring, to give a 60 mass % phosphoric acid solution. Aniline (407.5 g; 4.38 moles) was added to the reaction vessel over a 1 h period by means of a dropping funnel in the top of the reaction vessel. The stirred aniline phosphate was then cooled to −35.0° C. by passing a cooled 50/50 methanol water mixture through the vessel jacket. The oxidant ammonium persulfate (1,248 g; 5.47 moles) was dissolved in water (2,250 g), and the resulting solution was added to the cooled, stirred reaction mixture at a constant rate over a 30 h period.

The reactants were typically permitted to react for 46 h, after which the polyaniline precipitate was filtered from the reaction mixture and washed with about 25 L of water. The wet polyaniline filter cake was then mixed with a solution of 800 ml of 28% ammonium hydroxide solution mixed with 20 L of water and stirred for 1 h, after which the pH of the suspension was 9.4. The polyaniline slurry was then filtered and the polyaniline filtrate washed 4 times with 10 L of water per wash, followed by a washing with 2 L of isopropanol. The resulting polyaniline filter cake was placed in plastic trays and dried in a vacuum oven at 100° C. for 4 d.

The GPC molecular weight data were obtained as described for EXAMPLES 1-10 hereinabove, and the results for the molecular weight data and polyaniline yield are summarized in TABLE 4.

TABLE 4

| | Reaction | | | | | |
|---|---|---|---|---|---|---|
| Example | Temperature | Yield | Mₚ | M_{w} | Mₙ | |
| No. | (K) | (%) | (g/mol) | (g/mol) | (g/mol) | M_{w}/Mₙ |
| 20 | 273 | 87 | 120,000 | 138,000 | 21,800 | 6.3 |
| 21 | 263 | 91 | 144,000 | 176,000 | 34,000 | 5.2 |
| 22 | 253 | 90 | 170,000 | 249,000 | 32,000 | 7.8 |

### EXAMPLE 23

The procedure for Example 14 possessed the highest Mₙ value and its procedure was followed except that the quantity of aniline in the reaction mixture was increased to 11.5 moles. Water (6,470 g) was first added to a 50 L jacketed reaction vessel fitted with a mechanical stirrer. 85% phosphoric acid (15,530 g) was then added to the water, with stirring, to give a 60 mass % phosphoric acid solution (Hammett Acidity Function=−1.66 at 298 K). Aniline (1,071 g, 11.5 moles) was added to the reaction vessel over a 1 h period by means of a dropping funnel in the top of the reaction vessel. The stirred aniline phosphate was then cooled to −35.0° C. by passing a cooled 50/50 methanol water mixture through the vessel jacket. Ammonium persulfate oxidant (3,280 g, 14.37 moles) was dissolved in water (5,920 g), and the resulting solution was added to the cooled, stirred reaction mixture at a constant rate over a 30 h period. The temperature of the reaction mixture was maintained at 238±1.5 K during the reaction by controlling the temperature of the cooling solution (between 236 K and 231 K) for the duration of the reaction to ensure good product reproducibility between batches.

The reactants were typically reacted for 46 h, after which time the polyaniline precipitate was filtered from the reaction mixture and washed with about 25 L of water. The wet polyaniline filter cake was then mixed with a solution of 800 mL of 28% ammonium hydroxide solution mixed with 20 L of water and stirred for 1 h, after which the pH of the suspension was 9.4.

The polyaniline slurry was then filtered and the polyaniline filtrate washed 4 times with 10 L of water per wash, followed by a washing with 2 L of isopropanol. The resulting polyaniline filter cake was placed in plastic trays and dried in a vacuum oven at 100° C. for 4 d. The recovered mass of dried polyaniline was 974 g (10.7 moles) corresponding to a yield of 93.4%. The dried powder was vacuum sealed in a plastic bag and stored in a freezer at 255 K.

The GPC molecular weight data for this polyaniline powder was obtained using the procedure set forth for EXAMPLES 1-10 hereinabove, and the molecular weight distribution for this EB powder was M, of 283,000 g·mol⁻¹, Mₙ of 25,000 g·mol⁻¹ and Mₚ of 121,000 g·mol⁻¹.

C. Preparation of Polyaniline (Emeraldine Base) in Organic Acids

The syntheses of polyaniline described in Examples 1-23 have been performed at subzero temperatures in mineral acids having Hammett acidities less than about −0.5. However, it is possible to perform the synthesis of high-molecular-weight polyaniline in organic acids at these temperatures so long as the organic acids chosen prevent the reaction mixture from freezing at the desired temperature. The Hammett Acidity Functions of the reaction medium were greater than about −2 and lower than about 0.5 for the acids used. The reduced viscosity was measured for a 0.1 mass % solution in sulfuric acid as described hereinabove, and the GPC molecular weight data for the emeraldine base powders synthesized in organic acids was obtained as described hereinabove as well.

### EXAMPLE 24

A formic acid solution (100 g, 85 wt %) and aniline (9.31 g, 0.10 moles) were mixed together inside a 1 L jacketed reaction vessel that was cooled to 248 (Hammett Acidity Function is −0.42 at 298 K). This temperature was maintained throughout the reaction period. The oxidant ammonium persulfate (28.6 g, 0.125 moles) was dissolved in water (35.7 g) and added to the stirred reaction mixture using a peristaltic pump over a period of 24 h. After total reaction time of 25 h, the reaction mixture was filtered, washed with water until a colorless filtrate was obtained. The filter cake was subsequently deprotonated by mixing it in 100 ml of a 10% ammonium hydroxide solution and stirred for 1 h. The suspension was refiltered, rewashed with several liters of water until a colorless filtrate was obtained (with a final wash of 2-propanol) and then dried under vacuum at 343 K for 16 h. The mass of polymer obtained was 8.90 g, which corresponds to a yield of 98%. The reduced viscosity measurement of a 0.1 mass % solution in sulfuric acid was 1.72 dL·g⁻¹, which is only slightly lower than for polyaniline powder synthesized at 248 K in sulfuric acid (EXAMPLE 4). This suggests that organic acid solutions with Hammett acidity lower than about −0.5 or lower may also be used to obtain a reasonably high-molecular-weight polyaniline.

### EXAMPLE 25

A trifluoroacetic acid solution (100 g, 60 wt %) and aniline (9.31 g, 0.10 moles) were mixed together inside a 1 L jacketed reaction vessel that was cooled to 248 K. This temperature was maintained throughout the reaction period. The oxidant ammonium persulfate (28.6 g, 0.125 moles) was dissolved in water (35.7 g) and added to the stirred reaction mixture using a peristaltic pump over a period of 24 h. After total reaction time of 25 h, the reaction mixture was filtered, washed with water until a colorless filtrate was obtained. The filter cake was subsequently deprotonated by mixing it in 100 ml of a 10% ammonium hydroxide solution and stirred for 1 h. The suspension was refiltered, rewashed with several liters of water until a colorless filtrate was obtained (with a final wash of 2-propanol) and then dried under vacuum at 343 K for 16 h. The mass of polymer obtained was 8.80 g, which corresponds to a yield of 97%. The reduced viscosity measurement of a 0.1 mass % solution in sulfuric acid was 0.74 dL·g⁻¹, indicating that the molecular weight was lower than the synthesis of polyaniline described in EXAMPLE 24.

### EXAMPLE 26

A formic acid solution (100 g, 60 wt %) and aniline (4.66 g, 0.050 moles) were mixed together inside a 1 L jacketed reaction vessel that was cooled to 248 K (Hammett Acidity Function is +0.55 at 298 K). This temperature was maintained throughout the entire reaction. Ammonium persulfate oxidant (14.3 g, 0.063 moles) was dissolved in water (80 g) and added to the stirred reaction mixture using a peristaltic pump over a period of 3 h. After total reaction time of 20 h, the reaction mixture was filtered, washed with water until a colorless filtrate was obtained. The filter cake was subsequently deprotonated by mixing it in 100 ml of a 10% ammonium hydroxide solution and stirred for 1 h. The suspension was refiltered, rewashed with several liters of water until a colorless filtrate was obtained (with a final wash of 2-propanol) and then dried under vacuum at 343 K for 16 h. The GPC molecular weight distribution was M, =193,000 g·mol⁻¹, Mₚ =125,000 g·mol⁻¹, Mₙ=21,000 g·mol⁻¹ and M_{w}/Mₙ=6.4.

### EXAMPLE 27

An acetic acid solution (100 g, 60 wt %) and aniline (4.66 g, 0.050 moles) were mixed together inside a 1 L jacketed reaction vessel that was cooled to 248 K (Hammett Acidity Function is +0.25 at 298 K). This temperature was maintained throughout the reaction period. Ammonium persulfate (14.3 g, 0.063 moles) was dissolved in water (35.7 g) and added to the stirred reaction mixture using a peristaltic pump over a period of 12 h. After total reaction time of 20 h, the reaction mixture was filtered and washed with water until a colorless filtrate was obtained. The filter cake was subsequently deprotonated by mixing it in 100 ml of a 10% ammonium hydroxide solution and stirred for 1 h. The suspension was refiltered, rewashed with several liters of water until a colorless filtrate was obtained (with a final wash of 2-propanol) and then dried under vacuum at 343 K for 16 h. The GPC molecular weight distribution was M_{w}=55,700 g·mol⁻¹, Mₚ=20,200 g·mol⁻¹, Mₙ=9,410 g·mol⁻¹ and M_{w}/Mₙ of 5.9.

D. Preparation of Substituted Polyaniline (Emeraldine Base) and Co-Polymers

The synthesis of polyaniline in Examples 1-27 have been performed at subzero temperatures in which aniline was used as the monomer in reaction mixtures. However, it is possible to replace the aniline used in these examples with substituted anilines, and the resulting polymers possess increased solubility in organic solvents over the parent polyaniline. Also, co-polymers that comprise of aniline and substituted aniline can be similarly prepared. The GPC molecular weight data for the emeraldine base powders synthesized in organic acids was obtained as described hereinabove.

### EXAMPLE 28

A sulfuric acid solution (100 g, 28.8 wt %) and 2-methoxyaniline (12.3 g, 0.100 moles) were mixed together inside a 1 L jacketed reaction vessel that was cooled to 248 K (Hammett Acidity Function is −1.64 at 298 K). This temperature was maintained throughout the entire reaction. The oxidant ammonium persulfate (28.5 g, 0.10 moles) was dissolved in water (51.5 g) and added to the stirred reaction mixture using a peristaltic pump over a period of 10 h. After total reaction time of 23 h, the reaction mixture was filtered, washed with water until a colorless filtrate was obtained. The filter cake was subsequently deprotonated by mixing it in 100 ml of a 10% ammonium hydroxide solution and stirred for 1 h. The suspension was refiltered, rewashed with several liters of water until a colorless filtrate was obtained (with a final wash of 2-propanol) and then dried under vacuum at 343 K for 16 h. The GPC molecular weight distribution of the poly(2-methoxyaniline) powder was M_{w}=of 87,000 g/mol, Mₚ of 56,000 g/mol, Mₙ of 15,000 g/mol and M_{w}/Mₙ of 5.7.

### EXAMPLE 29

A phosphoric acid solution (200 g, 60 wt %) and 2-methoxyaniline (12.3 g, 0.100 moles) were mixed together inside a 1 L jacketed reaction vessel that was cooled to 238 K (Hammett Acidity Function is −1.66 at 298 K). This temperature was maintained throughout the entire reaction. The oxidant ammonium persulfate (28.5 g, 0.10 moles) was dissolved in water (51.5 g) and added to the stirred reaction mixture using a peristaltic pump over a period of 27 h. After a total reaction time of 47 h, the reaction mixture was filtered, washed with water until a colorless filtrate was obtained. The filter cake was subsequently deprotonated by mixing it in 100 ml of a 10% ammonium hydroxide solution and stirred for 1 h. The suspension was refiltered, rewashed with several liters of water until a colorless filtrate was obtained (with a final wash of 2-propanol) and then dried under vacuum at 343 K for 16 h. The GPC molecular weight distribution of the poly(2-methoxyaniline) powder as described hereinabove, gave M_{w}=87,000 g·mol⁻¹, Mₚ=78,000 g·mol⁻¹, Mₙ=19,000 g·mol⁻¹ and M_{w}/Mₙ=4.5.

### EXAMPLE 30

Water (35 g) was first added to a 250 mL jacketed reaction vessel fitted with a mechanical stirrer. 98% Sulfuric acid (20 g; 98%) was then added to the water, with stirring, to give a 38 mass % sulfuric acid solution (Hammett Acidity Function is −2.27 at 298 K). Distilled aniline (1.86 g, 0.020 moles) and metanilic acid (3.46 g, 0.020 moles) were added to the reaction vessel during constant mixing. The reaction mixture was then cooled to 263 K and maintained at this temperature throughout the entire reaction. Ammonium persulfate oxidant (11.4 g, 0.050 moles) was dissolved in water (35 g) and added to the stirred reaction mixture over a period of 20 minutes. After a total reaction time of 18 h, the mixture was filtered, then washed with water until a colorless filtrate was observed. The polyaniline powder was then dried under vacuum at 333 K for 5 h. 2.28 g of a copolymer of aniline and metanilic acid was obtained, giving a chemical yield of ˜44%.

E. Control of the Molecular Weight of Polyaniline (Emeraldine Base)

### EXAMPLES 31-34

A phosphoric acid solution (25 g, 20 wt %) and aniline (0.70 g, 0.0075 moles) were mixed together inside a 100 mL reaction vessel that was cooled to 273 K (Hammett Acidity Function is −0.15 at 298 K). This temperature was maintained throughout the entire reaction. Ammonium persulfate oxidant (1.71 g, 0.0075 moles) was dissolved in 20 wt % phosphoric acid solution (25 g) and added to the stirred reaction mixture over different intervals between 2 and 300 min. The different oxidant addition times are summarized in TABLE 5. Due to the different oxidant addition times, the total reaction time also varied between samples and is also summarized in TABLE 5. After the desired reaction time, the reaction mixture was filtered, washed with water until a colorless filtrate was obtained. The filter cake was subsequently deprotonated by mixing it in 50 ml of a 10% ammonium hydroxide solution and stirred for 1 h. The suspension was refiltered, rewashed with several liters of water until a colorless filtrate was obtained (with a final wash of 2-propanol) and then dried under vacuum at 343 K for 16 h.

TABLE 5

| Example | Oxidant Addition Time | Total Addition Time |
|---|---|---|
| No. | (min) | (min) |
| 31 | 2 | 53 |
| 32 | 65 | 92 |
| 33 | 144 | 170 |
| 34 | 298 | 298 |

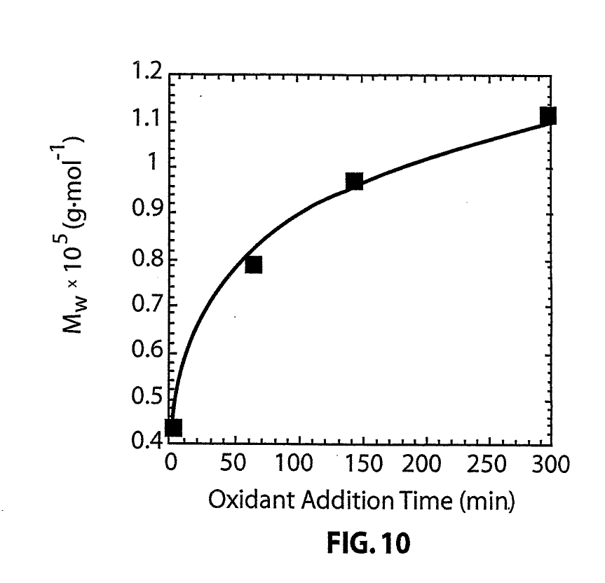

The molecular weights of these polyaniline powders were characterized using gel permeation chromatography (GPC) as described in EXAMPLES 1-10 hereinabove, and summarized in TABLE 6 and shown graphically in FIG. 10.

As the oxidant addition time is increased, the molecular weight of the polyaniline powder increased, which illustrates that an alternate approach to controlling the molecular weight of the emeraldine base powder.

TABLE 6

| | M_{w} | Mₙ | Mₚ | |
|---|---|---|---|---|
| Example | (g · mol⁻¹) | (g · mol⁻¹) | (g · mol⁻¹) | M_{w}/Mₙ |
| 31 | 43,700 | 3,700 | 17,900 | 11.9 |
| 32 | 76,200 | 13,600 | 45,600 | 5.6 |
| 33 | 97,000 | 16,900 | 63,900 | 5.7 |
| 34 | 114,000 | 21,600 | 88,000 | 5.3 |

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method for preparing chlorine-free polyaniline having a chosen molecular weight comprising: forming a reactive mixture at reaction temperatures below about 273 K comprising aniline monomer, a free-radical initiating oxidant, and an effective amount of non-chlorinated acid having a Hammett Acidity Function less than about 0.5 for keeping said reactive mixture from freezing in the absence of a freezing point depressing salt, with the proviso that if phosphoric acid is used, said phosphoric acid comprises greater than one phosphorus atom per molecule of acid; and maintaining said reactive mixture at a temperature such that the chosen polyaniline molecular weight is achieved.

2. The method as described in claim 1, further comprising the step of adding said free-radical initiating oxidant to said reaction mixture at a chosen rate such that the chosen polyaniline molecular weight is achieved.

3. The method as described in claim 1, wherein the temperature of said reactive mixture is maintained between about 223 K and about 273 K depending on the chosen molecular weight.

4. The method as described in claim 1, wherein said Hammett Acidity Function is less than about 0.5 and greater than about −2.

5. The method as described in claim 1, wherein the chosen molecular weight is greater than 50,000 g·mol⁻¹.

6. The method as described in claim 1, wherein said free-radical initiating oxidant is selected from the group consisting of persulfates, chromates, peroxides, azo compounds, hydroperoxides, peresters, and organometallics.

7. The method as described in claim 6, wherein said persulfates are selected from the group consisting of ammonium persulfate and sodium persulfate, and said dichromates are selected from the group consisting of ammonium dichromate, sodium dichromate and potassium dichromate.

8. The method as described in claim 1, wherein said acid is selected from the group consisting of sulfuric, benzoic, n-Butyric, chromic, hydrofluoric, iodic, acetic, formic, trifluoroacetic, periodic, octanoic, picric, nitric, nitrous, trifluoromethanesulfonic, benzenesulfonic, substituted benzenesulfonic, toluenesulfonic, dodecylbenzenesulfonic, 10-camphorsulfonic, polystyrene sulfonic, hydrogen selenide, hydrogen telluride, sulfanilic, and polyacrylic acids, and mixtures thereof.

9. The method as described in claim 1, wherein said aniline monomer is selected from the group consisting of aniline and substituted aniline.

10. The method as described in claim 9, wherein said substituted aniline is selected from the group consisting of o-anisidine and o-toluidine.

11. A method for preparing chlorine-free polyaniline having a chosen molecular weight comprising: forming a reactive mixture at reaction temperatures ranging between about 223 K and about 273 K comprising aniline monomer, a free-radical initiating oxidant, and an effective amount of non-chlorinated acid for keeping said reactive mixture from freezing in the absence of a freezing point depressing salt and for protonating said aniline monomer, with the proviso that if phosphoric acid is used, said phosphoric acid comprises greater than one phosphorus atom per molecule of acid; and maintaining said reactive mixture at a temperature such that the chosen polyaniline molecular weight is achieved.

12. The method as described in claim 11, further comprising the step of adding the oxidant to the aniline monomer at a chosen rate whereby the molecular weight of the polyaniline is selected.

13. The method as described in claim 11, wherein the temperature of said reactive mixture is maintained between about 223 K and about 273 K depending on the chosen molecular weight.

14. The method as described in claim 11, wherein the chosen molecular weight is greater than 50,000 g·mol⁻¹.

15. The method as described in claim 11, wherein said free-radical initiating oxidant is selected from the group consisting of persulfates, chromates, peroxides, azo compounds, hydroperoxides, peresters, and organometallics.

16. The method as described in claim 15, wherein said persulfates are selected from the group consisting of ammonium persulfate and sodium persulfate, and said dichromates are selected from the group consisting of ammonium dichromate, sodium dichromate and potassium dichromate.

17. The method as described in claim 11, wherein said acid is selected from the group consisting of sulfuric, benzoic, n-Butyric, chromic, hydrofluoric, iodic, acetic, formic, trifluoroacetic, periodic, octanoic, picric, nitric, nitrous, trifluoromethanesulfonic, benzenesulfonic, substituted benzenesulfonic, toluenesulfonic, dodecylbenzenesulfonic, 10-camphorsulfonic, polystyrene sulfonic, hydrogen selenide, hydrogen telluride, sulfanilic, and polyacrylic acids, and mixtures thereof.

18. The method as described in claim 11, wherein said aniline monomer is selected from the group consisting of aniline and substituted aniline.

19. The method as described in claim 18, wherein said substituted aniline is selected from the group consisting of o-anisidine and o-toluidine.

20. A reactive mixture suitable for preparing chlorine-free polyaniline having a chosen molecular weight at reaction temperatures below about 273 K in the absence of a freezing point depressing salt comprising: aniline monomer, a free-radical initiating oxidant, and a non-chlorinated acid having a Hammett Acidity Function less than about 0.5 and effective for preventing said reactive mixture from freezing, with the proviso that if phosphoric acid is used, said phosphoric acid comprises greater than one phosphorus atom per molecule of acid.

21. The mixture as described in claim 20, wherein said Hammett Acidity Function is less than about 0.5 and greater than about −2.

22. The mixture as described in claim 20, wherein the chosen molecular weight is greater than 50,000 g·mol⁻¹.

23. The mixture as described in claim 22, wherein said free-radical initiating oxidant is selected from the group consisting of persulfates, chromates, peroxides, azo compounds, hydroperoxides, peresters, and organometallics.

24. The mixture as described in claim 23, wherein said persulfates are selected from the group consisting of ammonium persulfate and sodium persulfate, and said dichromates are selected from the group consisting of ammonium dichromate, sodium dichromate and potassium dichromate.

25. The mixture as described in claim 20, wherein said acid is selected from the group consisting of sulfuric, benzoic, n-Butyric, chromic, hydrofluoric, iodic, acetic, formic, trifluoroacetic, periodic, octanoic, picric, nitric, nitrous, trifluoromethanesulfonic, benzenesulfonic, substituted benzenesulfonic, toluenesulfonic, dodecylbenzenesulfonic, 10-camphorsulfonic, polystyrene sulfonic, hydrogen selenide, hydrogen telluride, sulfanilic, and polyacrylic acids, and mixtures thereof.

26. The mixture as described in claim 20, wherein said aniline monomer is selected from the group consisting of aniline and substituted aniline.

27. The mixture as described in claim 26, wherein said substituted aniline is selected from the group consisting of o-anisidine and o-toluidine.

28. A mixture suitable for preparing chlorine-free polyaniline having a chosen molecular weight at reaction temperatures below about 273 K in the absence of a freezing point depressing salt comprising: aniline monomer, a free-radical initiating oxidant, and a non-chlorinated acid effective for preventing said reactive mixture from freezing and for protonating said aniline monomer, with the proviso that if phosphoric acid is used, said phosphoric acid comprises greater than one phosphorus atom per molecule of acid.

29. The mixture as described in claim 28, wherein the chosen molecular weight is greater than 50,000 g·mol⁻¹.

30. The mixture as described in claim 28, wherein said free-radical initiating oxidant is selected from the group consisting of persulfates, chromates, peroxides, azo compounds, hydroperoxides, peresters, and organometallics.

31. The mixture as described in claim 30, wherein said persulfates are selected from the group consisting of ammonium persulfate and sodium persulfate, and said dichromates are selected from the group consisting of ammonium dichromate, sodium dichromate and potassium dichromate.

32. The mixture as described in claim 28, wherein said acid is selected from the group consisting of sulfuric, benzoic, n-Butyric, chromic, hydrofluoric, iodic, acetic, formic, trifluoroacetic, periodic, octanoic, picric, nitric, nitrous, trifluoromethanesulfonic, benzenesulfonic, substituted benzenesulfonic, toluenesulfonic, dodecylbenzenesulfonic, 10-camphorsulfonic, polystyrene sulfonic, hydrogen selenide, hydrogen telluride, sulfanilic, and polyacrylic acids, and mixtures thereof.

33. The mixture as described in claim 28, wherein said aniline monomer is selected from the group consisting of aniline and substituted aniline.

34. The mixture as described in claim 33, wherein said substituted aniline is selected from the group consisting of o-anisidine and o-toluidine.
